(19) United States
(12) Patent Application Publication
(10) Pub. No.: US 2018/0035010 A1
(43) Pub. Date: Feb. 1, 2018

(54) SYSTEM AND METHOD FOR PRINTING A BANNER PAGE HAVING INDENTIFING INDICIA

(71) Applicant: KYOCERA Document Solutions Inc., OSAKA (JP)

(72) Inventor: EDWIN PHILIP LOCKWOOD, BREA, CA (US)

(73) Assignee: KYOCERA Document Solutions Inc., OSAKA (JP)

(21) Appl. No.: 15/222,602

(22) Filed: Jul. 28, 2016

(51) Int. Cl. H04N 1/44; H04N 1/00; H04N 1/32; G06K 9/00

(52) U.S. Cl. CPC H04N 1/444; G06K 9/00288; H04N 1/00344; H04N 1/32512; H04N 1/32133; H04N 2201/0094; H04N 2201/3205; H04N 2201/3236

(57) ABSTRACT

A printing system generating a personalized banner page has a client device that transmits print data. An image forming device receives the print data transmitted by the client device. A banner creation module is in communication with the client device and the image forming device. The banner creation module transmits a user selected personalized indicia to be inserted on a banner page to be printed with the print data to identify the user.

### TECHNICAL FIELD

The present application in general relates to printing devices, and more specifically, to a system and method that allows an individual to incorporate a user identified indicia on a banner page to allow printer administrators to manage and distribute print jobs from the printing devices to the originators of the print jobs.

### BACKGROUND

When multiple print jobs are printed on a shared printer, a banner page may be used to separate the print jobs. The banner page may be printed before the sheets of each print job to act as a partition between individual print jobs. Banner pages may be generated by an application running on a host system that originates the print job, or by a print driver installed between the host and the printer. The banner pages may also be generated by the printer itself.

When the banner page is generated, predefined fields in a banner page template may be filled in with various information related to the print job. For example, the banner page may include the user name of the person originating the print job, the name of the print job, name of an information processing terminal and IP address allocated to the terminal and the date and time the job was printed. Thus, the content of the banner pages is limited to data included in the print job.

While the banner page may include a name of the originator of the print out, the printer administrator may be unfamiliar with the originator and what the originator looks like. In these situations, the printer administrator may have to ask for a picture identification of the originator to verify ownership. Further, in large corporate setting, multiple people may have the same name. Thus, the printer administrator may not know proper ownership of the print job.

Therefore, it would be desirable to provide a system and method that overcomes the above. The system and method would allow the printer administrators to manage and distribute the output to the originator of the print job even if they don't know that person. The system and method would alleviate the need for ID to prove ownership when collecting a printed document.

### SUMMARY

In accordance with one embodiment, a printing system generating a personalized banner page is disclosed. The printing system has a client device that transmits print data. An image forming device receives the print data transmitted by the client device. A banner creation module is in communication with the client device and the image forming device. The banner creation module transmits a user selected personalized indicia to be inserted on a banner page to be printed with the print data to identify the user.

In accordance with one embodiment, a method of generating and printing a personalized banner page is disclosed. The method comprises: accessing a banner creation module on a computing device; selecting a user personalized indicia to identify a user; and attaching the user personalized indicia to the personalized banner page to identify a printed document with the user.

In accordance with one embodiment, a computing device is disclosed. The computing device has a processor. A display is coupled to the processor. A user interface is coupled to the processor for entering data into the computing device. A memory is coupled to the processor. The memory stores program instructions that when executed by the processor, causes the processor to: access a banner creation module stored in the memory of the computing device; select a user selected personalized indicia to identify the user; and attach the user selected personalized indicia to a personalized banner page to identify a printed document with the user.

### BRIEF DESCRIPTION OF THE DRAWINGS

The present application is further detailed with respect to the following drawings. These figures are not intended to limit the scope of the present invention but rather illustrate certain attributes thereof.

FIG. 1 is a diagram of an exemplary system for printing a banner page having a personalized indicia according to one aspect of the present application;

FIG. 2 is a simplified block diagram showing an illustrative computer system depicted in FIG. 1 in accordance with one aspect of the present application;

FIG. 3 is a simplified block diagram showing an illustrative mobile computer system depicted in FIG. 1 according to one aspect of the present application;

FIG. 4 is a simplified block diagram showing an illustrative image forming device depicted in FIG. 1 according to one aspect of the present application;

FIG. 5 is an exemplary embodiment of a flowchart depicting a method for forming a banner page having a personalized indicia according to one aspect of the present application;

FIG. 6 is an exemplary embodiment of a banner page having personalized indicia according to one aspect of the present application; and

FIG. 7 is an exemplary embodiment of a flowchart depicting a method for forming a banner page having a personalized indicia according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method relates to a system and method that allows an individual to incorporate a user identified indicia on a banner page to allow printer administrators to manage and distribute print jobs from the printing devices to the originators of the print job. The system and method may allow a user to take or upload a picture of the user or other unique identifying feature as part of print initiation process. This image may then be incorporated into a banner page as part of the print job so the starting point of that print job can easily be found amongst multiple print jobs.

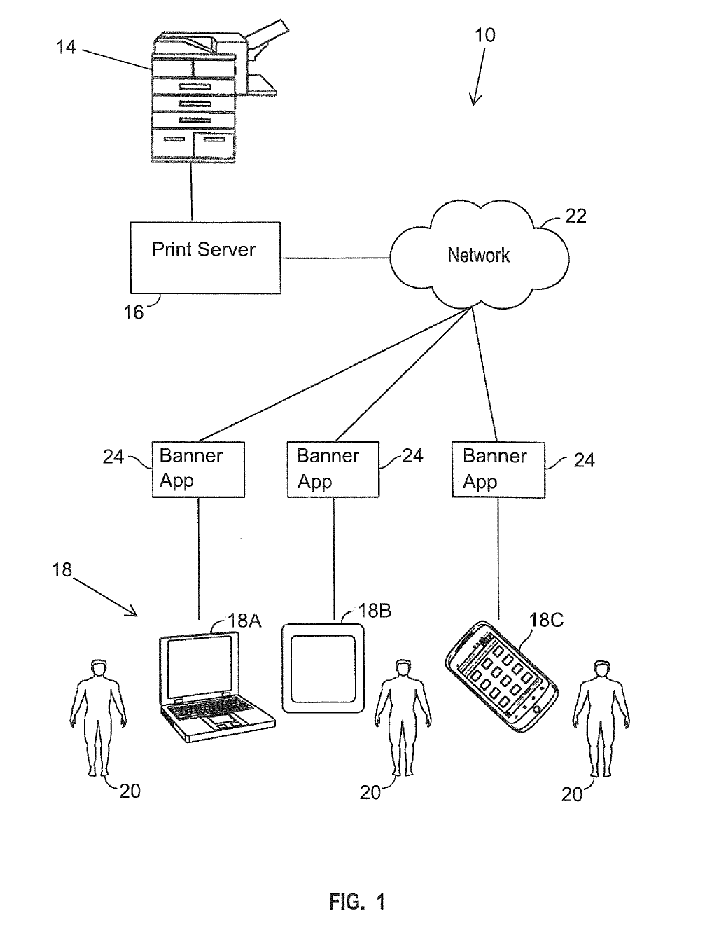

Referring now to FIG. 1, a system 10 may be shown. The system 10 may provide a printing network platform that may allow for a user to incorporate a user identified indicia on a banner page to allow printer administrators to manage and distribute print jobs from the printing devices to the originators of the print job. The components of the system 10 may be coupled through wired or wireless connections.

The system 10 may have an image forming device 14. The image forming device 14 may be any type of device having printing capabilities. For example, the image forming device 14 may be a printer, a copier, a fax machine, a multi-function peripheral including a scanner and one or more of functions of a copier, a facsimile device, and a printer and/or other types of rendering devices. The image forming device 14 may be used for outputting a print job and banner page as described below.

The image forming device 14 may be coupled to a print server 16. The print server 16 may be used to connect the image forming device 14 to one or more computing devices 18 over a network 22. The network 22 may be a local area network (LAN), a general wide area network (WAN), wireless local area network (WLAN) and/or a public network. The print server 16 may accept print jobs from the computing device 18 and may send the print jobs to the appropriate image forming device 14. The print server 16 may queue the jobs locally as print jobs may arrive more quickly than the image forming device 14 may be able to print.

Individuals 20 may use one or more computing devices 18 to send print jobs to the image forming device 14. The computing devices 18 may be a client computer system such as a desktop computer, handheld or laptop device, tablet, mobile phone device, server computer system, multiprocessor system, microprocessor-based system, network PCs, and distributed cloud computing environments that include any of the above systems or devices, and the like. The computing device 18 may be described in the general context of computer system executable instructions, such as program modules, being executed by a computer system as may be described below. In the embodiment shown in FIG. 1, the computing device 18 may be seen as a client computing system 18A, a tablet device 18B and a mobile phone device 18C. However, this should not be seen in a limiting manner as any computing device 18 described above may be used.

The computing devices 18 may be loaded with an operating system. The operating system of the computing device 18 may manage hardware and software resources of the computing device 18 and provide common services for computer programs running on the computing device 18. At least one of the computing devices 18 may be loaded with a banner creation application 24. The banner creation application 24 may allow the individual 20 using the computing device 18 to incorporate a user identified indicia on a banner page to allow printer administrators to manage and distribute print jobs from the image forming device 14 to the originators of the print job as will be described below.

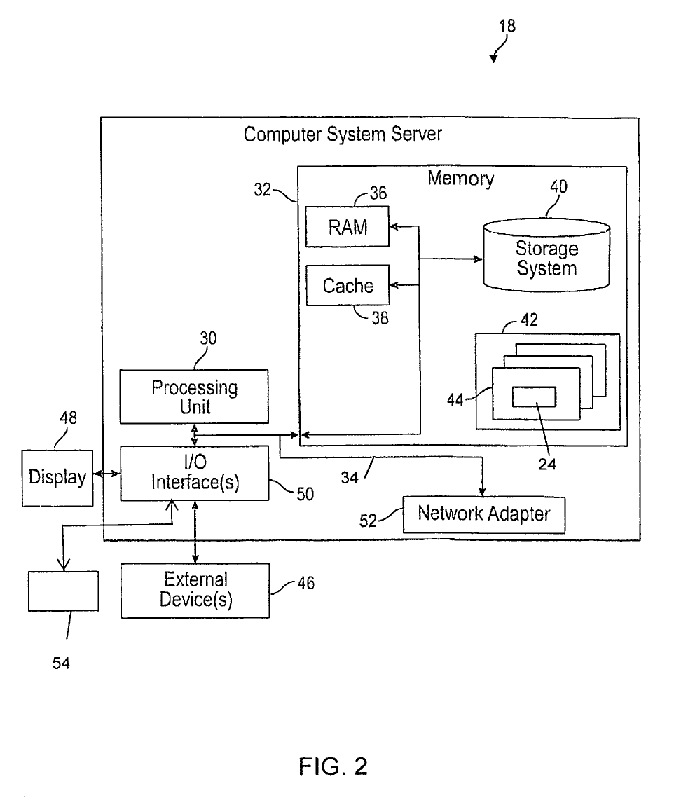

Referring now to FIG. 2, the client computing system 18A may be described in more detail in terms of the machine elements that provide functionality to the systems and methods disclosed herein. The components of the client computing system 18A may include, but are not limited to, one or more processors or processing units 30, a system memory 32, and a system bus 34 that couples various system components including the system memory 32 to the processor 30. The client computing system 18A may typically include a variety of computer system readable media. Such media may be chosen from any available media that is accessible by the client computing system 18A, including non-transitory, volatile and non-volatile media, removable and non-removable media. The system memory 32 could include one or more personal computing system readable media in the form of volatile memory, such as a random access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein. For example, the program modules 44 may store the banner creation application 24 which carries out the steps for the individual 20 to take and/or upload a user identified indicia to a banner page to allow printer administrators to manage and distribute print jobs from the image forming device 14 to the originators of the print job as will be described below.

The client computing system 18A may communicate with one or more external devices 46 such as a keyboard, a pointing device, a display 48, camera 54 and/or any similar devices (e.g., network card, modern, etc.). The display 48 may be a Light Emitting Diode (LED) display, Liquid Crystal Display (LCD) display, Cathode Ray Tube (CRT) display and similar display devices. Images captured by the camera 54 may be stored in the system memory 32. The external devices 46 may enable the personal computing system 18A to communicate with the image forming device 14 (FIG. 1). Such communication may occur via Input/Output (I/O) interfaces 50. Alternatively, the personal computing system 18A may communicate with one or more networks 22 (FIG. 1) such as a local area network (LAN), a general wide area network (WAN), and/or a public network via a network adapter 52. The client computing system 18A may be coupled to the one or more networks via a wired or wireless connection. As depicted, the network adapter 52 may communicate with the other components of the personal computing system 18A via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

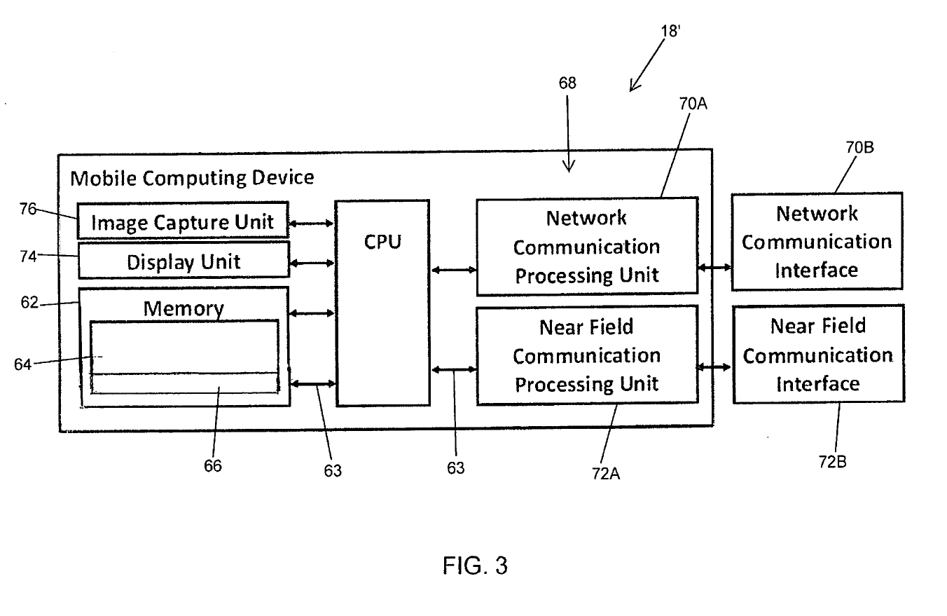

As shown in FIG. 1, the system 10 may have mobile computing devices 18′ such as the tablet device 18B and/or the mobile phone device 18C. The mobile computing devices 18′ may be wireless type devices which communicate with the network 22 through wireless connections. Referring to FIG. 3, the mobile computing devices 18′ may be described in more detail in terms of the machine elements that provide functionality to the systems and methods disclosed herein. The components of the mobile computing devices 18′ may include, but are not limited to one or more processors or processing units 60, a system memory 62, and a system bus 63 that couples various system components including the system memory 62 to the processor 60. The mobile computing device 18′ may typically include a variety of mobile computing device readable media. Such media could be chosen from any available media that is accessible by the mobile computing device 18′, including non-transitory, volatile and non-volatile media, removable and non-removable media. The system memory 62 may include one or more mobile computing device readable media in the form of volatile memory, such as a random access memory (RAM) and/or a cache memory.

The system memory 62 may include at least one program product/utility 64 having a set (e.g., at least one) of program modules 66 that may be configured to carry out the functions of embodiments of the invention. The program modules 66 may include, but is not limited to, an operating system, one or more application programs, other program modules, and program data. Each of the operating systems, one or more application programs, other program modules, and program data or some combination thereof, may include an implementation of a networking environment. The program modules 66 generally carry out the functions and/or methodologies of embodiments of the invention as described herein. For example, the program modules 66 may carry out the steps for the individual 20 (FIG. 1) to take and/or upload a user identified indicia to a banner page to allow printer administrators to manage and distribute print jobs from the image forming device 14 (FIG. 1) to the originators of the print job as will be described below.

The mobile computing device 18′ may have one or more communication modules 68. The communication modules 68 may allow the mobile computing device 18′ to communicate with one or more networks 22 (FIG. 1) such as a local area network (LAN), a general wide area network (WAN), wireless local area network (WLAN) and/or a public network, communicate with another mobile computing device 18′ as well as to communicate with the image forming device 14 (FIG. 1). In accordance with one embodiment, the communication modules 68 may include a network communication processing unit 70A coupled to a network communication interface 70B. The network communication processing unit 70A and the network communication interface 70B may allow the mobile computing device 18′ to communicate with one or more networks 22. These networks 22 may be a local area network (LAN), a general wide area network (WAN), a wireless local area network, a public network, a cellular network as well as other type of networks. The communication modules 68 may include a near field communication processing unit 72A coupled to a near field communication interface 72B. The near field communication processing unit 72A and the near field communication interface 72B may allow the mobile computing device 18′ to communicate with other electronic devices located near the mobile computing device 18′. In accordance with one embodiment, the mobile computing device 18′ to communicate with other electronic devices located near the mobile computing device 18′ using Bluetooth, infrared, or similar communication protocols.

The mobile computing device 18′ may include a display unit 76. The display unit 76 may be used to show information on the mobile computing device 18′. The display unit 76 may be an LED display unit, Thin Film Transistor (TFT) display unit, LCD display unit, and similar display devices. In accordance with one embodiment, the display unit 76 may be a touch screen to allow the individual 20 (FIG. 1) to enter data into the mobile computing device 18′ thereby allowing the display unit 76 to function as an input device. In some other example embodiments, the mobile computing device 18′ may include the display unit 74 and separate input devices.

The mobile computing device 18′ may have a camera 76. The camera 76 may be used to capture images. The images captured may be stored in the system memory 62 of the mobile computing device 18′.

In some embodiments, the mobile computing device 18′ may be configured to perform the same or similar operations as that of the client computing device 18A. For example, the mobile computing device 18A′ may be used to generate a document. The mobile computing device 18A′ may further be used to transmit the document to the image forming device 14 for printing.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more mobile computer readable media (for example, storage system 62) may be utilized. In the context of this disclosure, a computer readable storage medium may be any tangible or non-transitory medium that can contain, or store a program (for example, the program product 64) for use by or in connection with an instruction execution system, apparatus, or device. A mobile computer readable storage medium may be, for example, but not limited to, an electronic, magnetic, optical, electromagnetic, infrared, or semiconductor system, apparatus, or device, or any suitable combination of the foregoing.

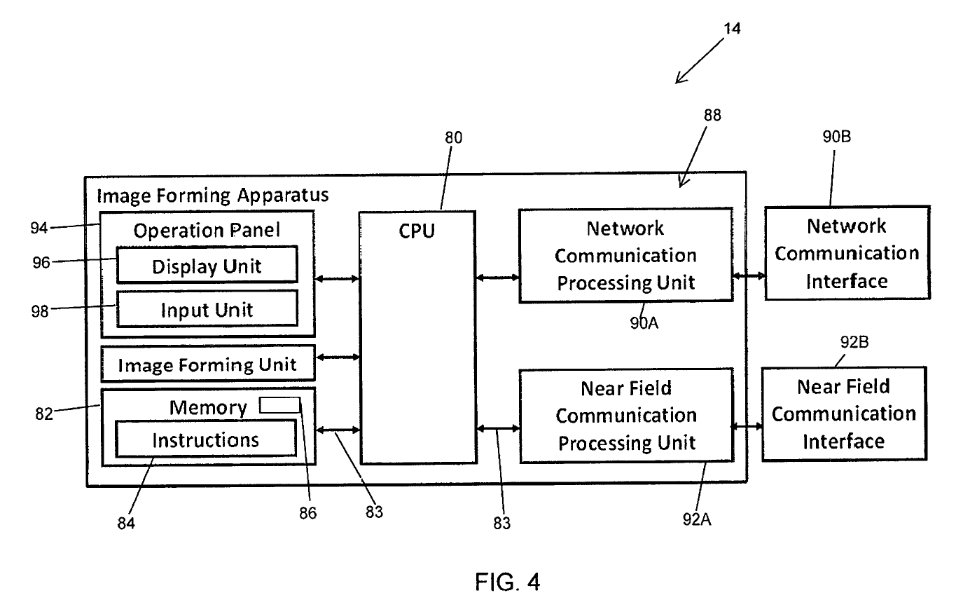

Referring now to FIG. 4, the image forming device 14 may be described in more detail in terms of the machine elements that provide functionality to the systems and methods disclosed herein. The components of the image forming device 14 may include, but are not limited to, one or more processors or processing units 80, a system memory 82, and a system bus 83 that may couple various system components including the system memory 82 to the processor 80. The image forming device 14 may typically include a variety of computer system readable media. Such media could be chosen from any available media that is accessible by the image forming device 14, including non-transitory, volatile and non-volatile media, removable and non-removable media. The system memory 82 could include one or more image forming device readable media in the form of volatile memory, such as a random access memory (RAM) and/or a cache memory. By way of example only, the system memory 82 may be provided for reading from and writing to a non-removable, non-volatile magnetic media device typically called a “hard drive”.

The system memory 82 may include at least one program product/utility 84 having a set (e.g., at least one) of program modules 86 that may be configured to carry out the functions of embodiments of the invention. The program modules 86 may include, but is not limited to, an operating system, one or more application programs, other program modules, and program data. Each of the operating systems, one or more application programs, other program modules, and program data or some combination thereof, may include an implementation of a networking environment. The program modules 86 may include procedures such as a page converter, rasterizer, compression code, page print scheduler, print engine manager, banner page generator, and similar printing applications. The program modules 86 generally carry out the functions and/or methodologies of embodiments of the invention as described herein.

The image forming device 14 may have one or more communication modules 88. The communication modules 68 may allow the image forming device 14 to communicate with one or more networks (i.e., network 22 shown in FIG. 1) such as a local area network (LAN), a general wide area network (WAN), wireless local area network (WLAN) and/or a public network. In accordance with one embodiment, the communication modules 88 may include a network communication processing unit 90A coupled to a network communication interface 90B. The network communication processing unit 90A and the network communication interface 90B may allow the image forming device 14 to communicate with one or more networks 22 (FIG. 1). These networks 22 may be a local area network (LAN), a general wide area network (WAN), a wireless local area network, a public network, a cellular network as well as other type of networks. The communication modules 88 may include a near field communication processing unit 92A coupled to a near field communication interface 92B. The near field communication processing unit 92A and the near field communication interface 92B may allow the image forming device 14 to communicate with other electronic devices located near the image forming device 14 using Bluetooth, infrared or similar communication protocols.

The image forming device 14 may include an operation panel 94. The operation panel may include a display unit 96 and an input unit 98 for facilitating human interaction with the image forming device 14. The display unit 96 may be any electronic video display, such as a LCD display, LED display and similar display types. The input unit 98 may include any combination of devices that allow users to input information into the operation panel 94, such as buttons, a keyboard, switches, and/or dials. In addition, the input unit 98 may include a touch-screen digitizer overlaid onto the display unit 96 that can sense touch and interact with the display unit 96.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 82) may be utilized. In the context of this disclosure, a computer readable storage medium may be any tangible or non-transitory medium that can contain, or store a program (for example, the program product 86) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

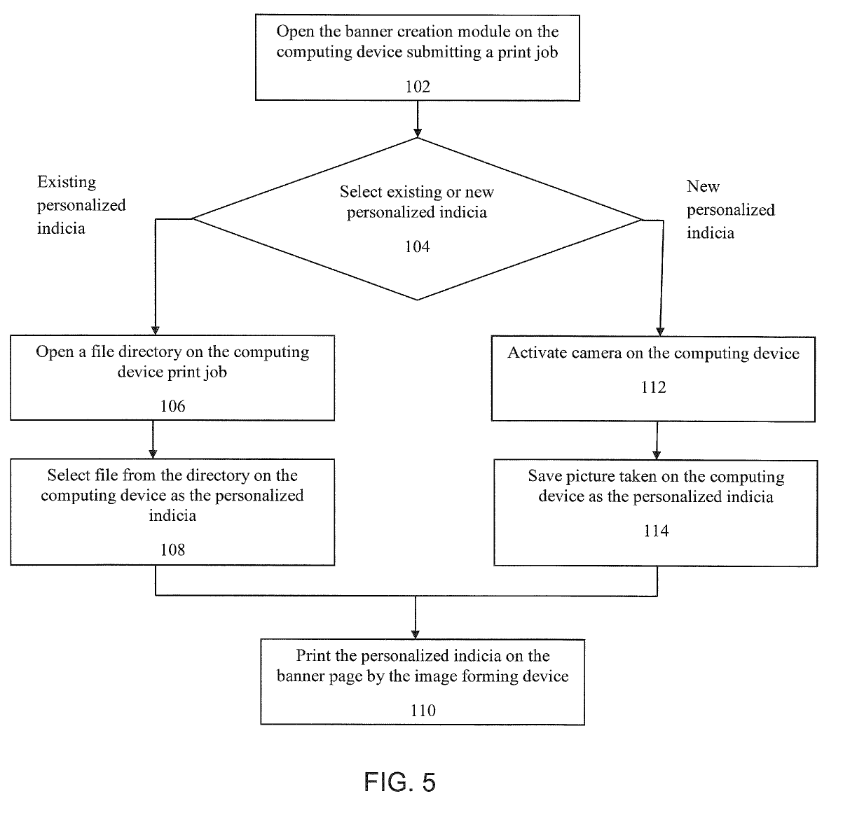

Referring now to FIGS. 1-5, operation of the system 10 in accordance with one exemplary embodiment may be seen. The method 100 shown in FIG. 5 may be for a computing device 18 which has the banner creation application 24 loaded therein. In this embodiment, the computing device 18 may be described as the client computing system 18A, however, the method is applicable to any computing device 18 which has the banner creation application 24 loaded therein that is sending a print job to the image forming device 14. Prior to sending the print job, the individual 20 may open the banner creation application 24 on the client computing device 18A as shown in 102. The individual 20 may use one or more of the external devices 46 to select and open the banner creation application 24. For example, the individual 20 may use a keyboard, a pointing device or similar I/O devices to click on an icon, open a menu and select, or otherwise select and open the banner creation application 24.

When the banner creation application 24 is open, a banner creation page may direct the individual 20 to select an existing personalized indicia from the system memory 32 of the client computing device 18A or to add a new personalized indicia as shown in 104. If the individual 20 chooses to select an existing personalized indicia from the system memory 32 of the client computing device 18A, the banner creation application 24 may direct the individual 20 to a file directory of the client computing device 18A as shown in 106. In the file directory, the individual 20 may select a file associated with an existing personalized indicia to add to a banner page to be printed with the print job as shown in 108. The existing personalized indicia may be a photo, a personalized emoji file such as a cartoon sketch of the individual 20, or other personalized indicia which may help a print administrator or others recognize the individual 20. The selected file may then be saved in the banner creation application 24.

If the individual 20 chooses to add a new personalized indicia, the banner creation application 24 may activate a camera 54 on the client computing device 18A as shown in 112. The individual 20 may then take a new photograph (i.e., selfie) which may be used as the personalized indicia. After a new photograph has been taken, the banner creation application 24 may ask if the individual 20 would like to use the new photograph taken. If the individual 20 selects “Yes”, the new photograph taken may be saved in the banner creation application 24. If the individual 20 selects “No”, the individual 20 may then take another new photograph (i.e., selfie) which may be used as the personalized indicia. The individual 20 may continue to take new photographs until the individual 20 selects “Yes and the new photograph taken is saved in the banner creation application 24 as shown in 114 as the new personalized indicia.

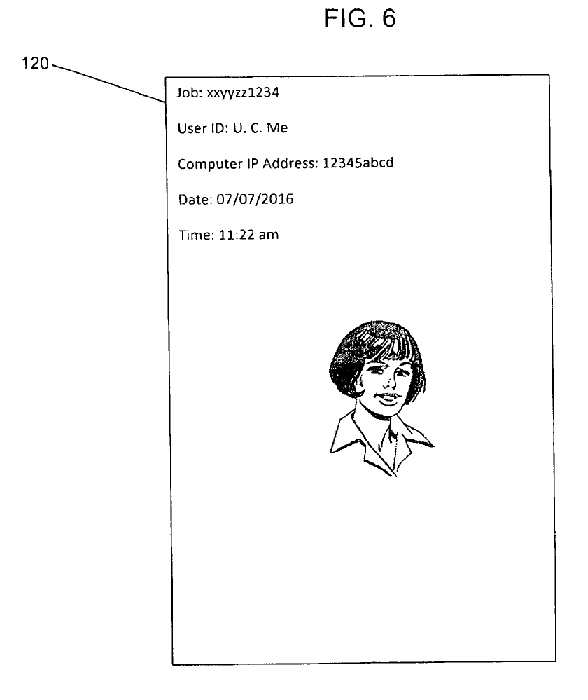

When the individual 20 sends a print job to the image forming device 14, the personalized indicia saved as well as other information such as: user name, computer IP address, time sent and the like may be inserted onto a banner page 120 (FIG. 6) and printed on the image forming device 14 as shown in 110. In accordance with one embodiment, the banner creation application 24 may create the banner page 120 with the personalized indicia as well as other information such as: user name, computer IP address, time sent and the like and transmit the banner page and print job to the image forming device 14.

Alternatively, the file of the personalized indicia as well as other information such as: user name, computer IP address, time sent and the like may be sent to the image forming device 14. The banner page generator of the image forming device 14 may add this information as well as other information such as job number, time printed, and other print job information to the banner page 120. The image forming device 14 may then print the banner page 120 as well as the print job sent by the computing device 14.

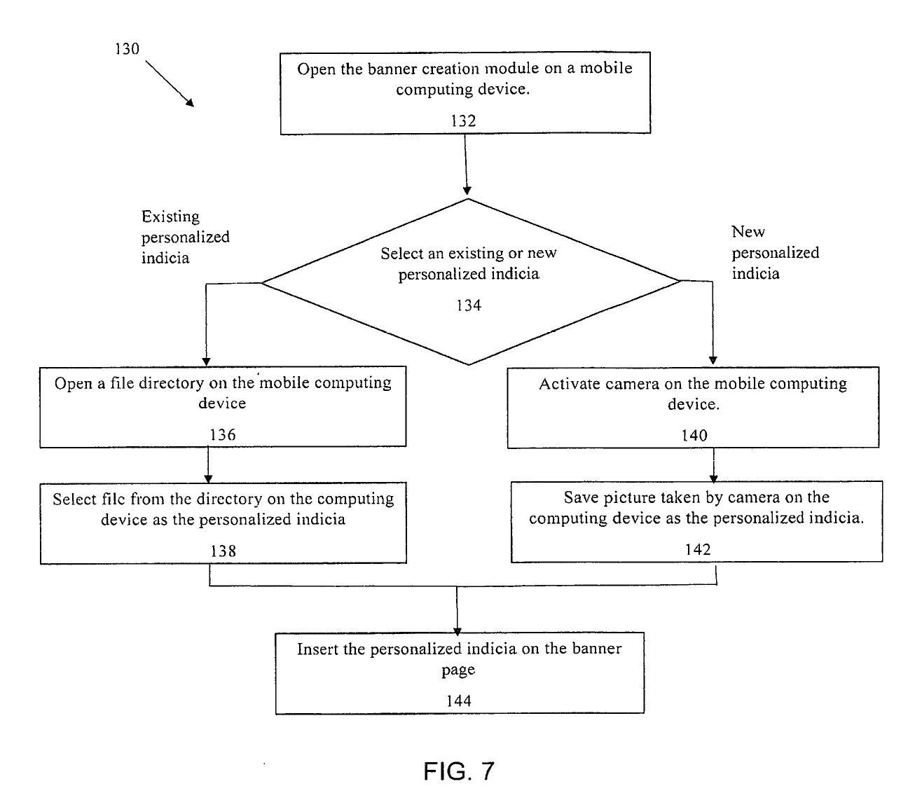

Referring now to FIGS. 1-4 and 6-7, operation of the system 10 in accordance with one exemplary embodiment may be seen. The method 130 shown in FIG. 7 may be for a computing device 18 which does not have the banner creation application 24 loaded therein. In this embodiment, the computing device 18 may be described as the client computing system 18A, however, the method is applicable to any computing device 18 which does not have the banner creation application 24 loaded therein. The client computing device 18A may wish to send a print job to the image forming device 14. Prior to sending the print job, the individual 20 may open the banner creation application 24 on a mobile computing device 18′ of the individual 20. The individual 20 may use the display unit 76 of the mobile computing device 18′ if the display unit 76 is a touch screen to select and open the banner creation application 24. Alternatively, the individual 20 may use other I/O devices such as a keyboard, a pointing device or the like to click on an icon, open a menu and select, or otherwise select and open the banner creation application 24 as shown in 132.

When the banner creation application 24 is open, a banner creation page may direct the individual 20 to select an existing personalized indicia from the system memory 62 of the mobile computing device 18′ or to add a new personalized indicia as shown in 134. If the individual 20 chooses to select an existing personalized indicia from the system memory 32 of the mobile computing device 18′, the banner creation application 24 may direct the individual 20 to a file directory of the mobile computing device 18′ as shown in 136. In the file directory, the individual 20 may select a file associated with an existing personalized indicia as shown in 138. The existing personalized indicia may be a photo, a personalized emoji file such as an animated version of the individual 20, or other personalized indicia which may help a print administrator or others recognize the individual 20. The selected file may then be saved in the banner creation application 24.

If the individual 20 chooses to add a new personalized indicia, the banner creation application 24 may activate a camera 76 on the mobile computing device 18′ as shown in 140. After a new photograph has been taken, the banner creation application 24 may ask if the individual 20 would like to use the new photograph taken. If the individual 20 selects “Yes”, the new photograph taken may be saved in the banner creation application 24. If the individual 20 selects “No”, the individual 20 may then take another new photograph (i.e., selfie) which may be used as the personalized indicia. The individual 20 may continue to take new photographs until the individual 20 selects “Yes” and the new photograph taken is saved in the banner creation application 24 as shown in 142.

Once the file of the personalized indicia is saved in the banner creation application 24, the personalized indicia may be inserted onto a banner page (FIG. 6) as shown in 144. In accordance with one embodiment, the banner creation application 24 in the mobile computing device 18′ may create the banner page 120 with the personalized indicia. The banner page 120 may be saved in the system memory 62 of the mobile computing device 18′. The mobile computing device 18′ may transfer the banner page 120 created to the computing device 18. The mobile computing device 18′ may transfer the banner page 120 to the computing device 18 through wireless connections. For example, the mobile computing device 18′ may transfer the file via wirelessly through the network 22. Alternatively, the mobile computing device 18′ may transfer the file of the personalized indicia to the computing device 18 through a direct wireless connection such as Bluetooth, Infrared or similar wireless communication protocols. When the individual 20 sends a print job to the image forming device 14, the computing device 18 may send the banner page 120 created by the mobile computing device 18′ to the image forming device 14.

Alternatively, the mobile computing device 18′ may transfer the banner page 120 created to the image forming device 14 prior to the computing device 18 sending the print job. The mobile computing device 18′ may transfer the banner page 120 to the image forming device 14 through wireless connections. For example, the mobile computing device 18′ may transfer the banner page 120 wirelessly through the network 22. Alternatively, the mobile computing device 18′ may transfer the banner page 120 through a direct wireless connection such as Bluetooth, Infrared or similar wireless communication protocols. Prior to the individual 20 sends a print job to the image forming device 14, the individual 20 may use the mobile computing device 18′ to send the banner page 120 created by the mobile computing device 18′ to the image forming device 14.

Alternatively, the mobile computing device 18′ may send the file of the personalized indicia to the computing device 18 which does not have the banner creation application 24. The computing device 18′ may transfer the file of the personalized indicia to the computing device 18 through wireless connections. For example, the mobile computing device 18′ may transfer the file wirelessly through the network 22. Alternatively, the mobile computing device 18′ may transfer the file of the personalized indicia to the computing device 18 through a direct wireless connection such as Bluetooth, Infrared or similar wireless communication protocols.

When the individual 20 sends a print job to the image forming device 14, the personalized indicia as well as other information such as: user name, computer IP address, time and the like may be inserted onto a banner page 120 and printed on the image forming device 14. The personalized indicia and other information may be inserted onto a banner page 120 created by the computing device 18 and sent to the image forming device 14 with the print job. Alternatively, the personalized indicia and other information may be sent to the image forming device 14 along with the print job by the computing device 14. The image faulting device 14 may insert the personalized indicia and other information onto a banner page 120 created by the image forming device 14 and print the banner page 120 and print job.

Alternatively, the mobile computing device 18′ may transfer the file of the personalized indicia directly to the image forming device 14 through wireless connections prior to the computing device 18 sending the print job to the image forming device 14. The mobile computing device 18′ may transfer the file wirelessly through the network 22 or directly through Near Field Communication (NFC) protocol. Once the mobile computing device 18′ transfers the file of the personalized indicia to the image forming device 14, the individual 20 may then send the print job from the computing device 18 to the image forming device 14.

The foregoing description is illustrative of particular embodiments of the invention, but is not meant to be a limitation upon the practice thereof. The following claims, including all equivalents thereof, are intended to define the scope of the invention.

1. A printing system generating a personalized banner page comprising:
a client device transmitting print data;
an image forming device receiving the print data transmitted by the client device;
a camera coupled to the client device;
a memory storing one or more personalized indicia including one or more personalized photographs; and
a banner creation module in communication with the client device and the image forming device, the banner creation module configured to:
display a banner creation page;
direct a user of the client device to one of: select an existing personalized photographs from the memory or add a new personalized photograph for inserting into the banner page to identify the user;
if the user selects to add the new personalized photograph activate the camera, and take the new personalized photograph of the user;
if the user selects to select the existing personalized photograph, select the existing personalized photograph stored in the memory; and
transmit one of the existing personalized photograph selected from the memory or the new personalized photograph taken to be inserted on the banner page to be printed with the print data to identify the user.

2. The printing system of claim 1, comprising a server coupled to the client device the image forming device and the banner creation module transmitting the print data from the client device to the image forming device and the one of the existing personalized photograph stored in the memory or the new personalized photograph taken from the banner creation module to the image forming device.

3. The printing system of claim 1, wherein the banner creation module allowing the user to take the new personalized photograph or add the existing personalized photograph stored in the memory to the banner page to identify the user.

4. The printing system of claim 1, wherein the client device houses the banner creation module, the banner creation module allowing the user to take the new personalized photograph or add the existing personalized photograph stored in the memory to the banner page to identify the user.

5. (canceled)

6. The printing system of claim 1, wherein the client device is a wireless computing device, the wireless computing device coupled to the image forming device, the wireless computing device housing, the banner creation module, and wirelessly transmitting the one of the existing personalized photograph selected from the memory or the new personalized photograph taken to the image forming device.

7. The printing system of claim 6, wherein the camera is coupled to the wireless computing device, the camera allowing the user to take the new personalized photograph to add to the banner page to identify the user or add the existing personalized photograph stored in the memory to the banner page to identify the user.

8. The printing system of claim 1, wherein the client device is a wireless computing device coupled to the image forming device, the wireless computing device housing the banner creation module, and wirelessly transmitting the one of the existing personalized photograph selected from the memory or the new personalized photograph taken to the image forming device.

9. The printing system of claim 8, wherein the camera is coupled to the wireless computing device, the camera allowing the user to take the new personalized photograph to add to the banner page to identify the user or add the existing personalized photograph stored in the memory to the banner page to identify the user.

10. A method of generating and printing a personalized banner page comprising:
accessing a banner creation module en a computing device;
selecting a user personalized indicia to identify a user, wherein selecting the user personalized indicia comprises:
adding one of an existing personalized photograph selected from a memory or taping a new personalized photograph for inserting into the banner page to identify the user;
wherein taking, the new personalized photograph comprises:
activating a camera; and
taking the new personalized photograph of the user with the camera;
wherein adding the existing personalized photograph comprises:
selecting the existing personalized photograph from the memory, and
attaching one of the new personalized photograph taken by the camera or the existing personalized photograph selected from the memory to the personalized banner page to identify a printed document with the user.

11. The method of claim 10, wherein the computing device is a wireless computing device.

12. (canceled)

13. (canceled)

14. The method of claim 12, comprising:
accessing a photo album stored in the memory on the wireless computing device; and
selecting the existing personalized photograph from the photo album to identify the user.

15. The method of claim 11, comprising transmitting print data forming the printed document to the image forming device from a client device, wherein the client device and the wireless computing device are separate devices.

16. A computing device comprising:
a processor;
a display coupled to the processor;
a user interface coupled to the processor for entering data into the computing device; and
a memory coupled to the processor, the memory storing program instructions that when executed by the processor, causes the processor to:
access a banner creation module stored in the memory of the computing device;
select, a user selected personalized photograph to identify the user comprising:
adding one of an existing personalized photograph selected from the memory or taking a new personalized photograph for inserting into the banner page to identify the user;
wherein taking the new personalized photograph comprises:
activating a camera; and
taking the new personalized photograph of the user with the camera;
wherein adding the existing personalized photograph comprises:
selecting the existing personalized photograph from the memory, and
adding the existing personalized photograph selected to the banner pace;
attach the user selected personalized photograph to a personalized banner page to identify, a printed document with the user.

17. (canceled)

18. (canceled)

19. (canceled)

20. The computing device of claim 16, wherein the memory storing program instructions that when executed by the processor, causes the processor to transmit print data forming the printed document to the image forming device from a client device.
